(19) United States
(12) Patent Application Publication
(10) Pub. No.: US 2026/0308355 A1
(43) Pub. Date: Oct. 8, 2026

(54) ADDITIVE COMPOSITION AND POLYMER COMPOSITION CONTAINING THE SAME

(71) Applicant: Milliken & Company, Spartanburg, SC (US)

(72) Inventors: Chi-Chun Tsai, Greer, SC (US); Darin L. Dotson, Moore, SC (US); Keith Alan Keller, Spartanburg, SC (US)

(21) Appl. No.: 19/635,915

(22) Filed: Apr. 1, 2026

Related U.S. Application Data
(60) Provisional application No. 63/783,561, filed on Apr. 4, 2025.

(51) Int. Cl. C08K 5/098; C08K 3/04; C08K 3/26; C08K 3/34

(52) U.S. Cl. CPC C08K 5/098; C08K 3/04; C08K 3/26; C08K 3/34; C08K 2003/267

(57) ABSTRACT

An additive composition comprises a calcium salt of rel-(1R,2S)-cyclohexane-1,2-dicarboxylic acid, a zinc salt of a saturated C₁₄-C₂₀ alkyl carboxylic acid, and a layered double hydroxide mineral. A polymer composition comprises a polypropylene polymer and the additive composition described above.

### TECHNICAL FIELD OF THE INVENTION

The present application relates to additive compositions containing a nucleating agent in combination with other polymer additives. The additive compositions can be used to nucleate polymers.

### BACKGROUND OF THE INVENTION

Polyolefins are a group of polymer resins that are particularly versatile. Polyolefins are semicrystalline polymers. A polyolefin which has been allowed to cool relatively slowly (e.g., such as the cooling that takes place during the production of molded plastic parts) contains amorphous regions in which the polymer chains are randomly arranged and crystalline regions in which the polymer chains have assumed an orderly configuration. Within these crystalline regions of the polyolefin, the polymer chains align into domains commonly referred to as “crystalline lamellae.” Under normal processing conditions, the crystalline lamellae grow radially in all directions as the polyolefin polymer cools from the molten state. This radial growth results in the formation of spherulites, which are spherical semicrystalline regions composed of multiple crystalline lamellae interrupted by amorphous regions. The size of the spherulites is affected by several parameters and can range from hundreds of nanometers to millimeters in diameter. When the spherulite size is appreciably larger than the wavelength of visible light, the spherulites will scatter visible light passing through the polymer. This scattering of visible light results in a hazy appearance which is commonly referred to as “polymer haze” or simply “haze.” While appreciable levels of polymer haze may be acceptable in some applications, there are certain applications (e.g., storage containers) in which consumers desire relatively transparent plastics and therefore require correspondingly low haze levels.

Several nucleating agents for thermoplastic polymers are known in the art. These nucleating agents generally function by forming nuclei or providing sites for the formation and/or growth of crystals in the thermoplastic polymer as it solidifies from a molten state. The nuclei or sites provided by the nucleating agent allow the crystals to form within the cooling polymer at a higher temperature and/or at a more rapid rate than the crystals will form in the virgin, non-nucleated thermoplastic polymer. These effects can then permit processing of a nucleated thermoplastic polymer composition at cycle times that are shorter than the virgin, non-nucleated thermoplastic polymer.

Some nucleating agents are able to reduce the spherulite size of certain polymers (e.g., polypropylene) to such an extent that the polymer haze is appreciably and noticeably reduced (i.e., the scattering of visible light passing though the polymer is reduced). Such nucleating agents are very beneficial because they enable the polymer to be used in applications where lower haze levels are required or at least desired. In addition to such improvements in optical properties, a desirable nucleating agent can improve other physical properties of the polymer, such as the stiffness or impact resistance. Such improvements again broaden the number of applications or end uses for which the nucleated polymer is suited. And while many nucleating agents can provide one of these physical property improvements, relatively few nucleating agents can provide a desirable combination of two or more physical property enhancements.

In view of the above, a need therefore remains for nucleating agents for thermoplastic polymers, such as polypropylene, and additive compositions containing such nucleating agents that provide a desirable combination of, for example, low haze and high stiffness. The additive compositions and polymer compositions described herein are intended to address such need.

### BRIEF SUMMARY OF THE INVENTION

In a first embodiment, the invention provides an additive composition comprising a calcium salt of rel-(1R,2S)-cyclohexane-1,2-dicarboxylic acid, a zinc salt of a saturated C₁₄-C₂₀ alkyl carboxylic acid, and a layered double hydroxide mineral. The layered double hydroxide mineral can be selected from the group consisting of aluminum magnesium hydroxide carbonate, aluminum magnesium zinc hydroxide carbonate, and mixtures thereof.

In a second embodiment, the invention provides a polymer composition comprising a polypropylene polymer and an additive composition as described above.

### DETAILED DESCRIPTION OF THE INVENTION

In a first embodiment, the invention provides an additive composition comprising a calcium salt of rel-(1R,2S)-cyclohexane-1,2-dicarboxylic acid, a zinc salt of a saturated C₁₄-C₂₀ alkyl carboxylic acid, and a layered double hydroxide mineral.

The additive composition can contain any suitable calcium salt of rel-(1R,2S)-cyclohexane-1,2-dicarboxylic acid or mixture of such salts. In one embodiment, the calcium salt of rel-(1R,2S)-cyclohexane-1,2-dicarboxylic acid in the additive composition is anhydrous calcium rel-(1R,2S)-cyclohexane-1,2-dicarboxylate. In another embodiment, the calcium salt of rel-(1R,2S)-cyclohexane-1,2-dicarboxylic acid in the additive composition is calcium rel-(1R,2S)-cyclohexane-1,2-dicarboxylate monohydrate. In another embodiment, the calcium salt of rel-(1R,2S)-cyclohexane-1,2-dicarboxylic acid in the additive composition is a mixture of anhydrous calcium rel-(1R,2S)-cyclohexane-1,2-dicarboxylate and calcium rel-(1R,2S)-cyclohexane-1,2-dicarboxylate monohydrate. In such an embodiment, the anhydrous calcium rel-(1R,2S)-cyclohexane-1,2-dicarboxylate and calcium rel-(1R,2S)-cyclohexane-1,2-dicarboxylate monohydrate can be present in the additive composition in any suitable relative amounts. Preferably, the anhydrous calcium rel-(1R,2S)-cyclohexane-1,2-dicarboxylate and calcium rel-(1R,2S)-cyclohexane-1,2-dicarboxylate monohydrate are present in the additive composition in a molar ratio (moles of anhydrous calcium rel-(1R,2S)-cyclohexane-1,2-dicarboxylate to moles of calcium rel-(1R,2S)-cyclohexane-1,2-dicarboxylate monohydrate) of about 1:99 to about 99:1, more preferably about 1:19 to about 19:1. In another preferred embodiment, the anhydrous calcium rel-(1R,2S)-cyclohexane-1,2-dicarboxylate and calcium rel-(1R,2S)-cyclohexane-1,2-dicarboxylate monohydrate are present in the additive composition in a molar ratio (moles of anhydrous calcium rel-(1R,2S)-cyclohexane-1,2-dicarboxylate to moles of calcium rel-(1R,2S)-cyclohexane-1,2-dicarboxylate monohydrate) of about 3:1 to about 99:1.

The additive composition additionally comprises a zinc salt of a saturated C₁₄-C₂₀alkyl carboxylic acid. Suitable saturated C₁₄-C₂₀ alkyl carboxylic acids include tetradecanoic acid, hexadecanoic acid, octadecanoic acid, and icosanoic acid. Preferably, the saturated C₁₄-C₂₀ alkyl carboxylic acid is octadecanoic acid, meaning that the zinc salt of a saturated C₁₄-C₂₀ alkyl carboxylic acid preferably is zinc octadecanoate. The saturated C₁₄-C₂₀ alkyl carboxylic acids used in making such zinc salts can, in some embodiments, be derived from natural sources that contain a mixture of two or more such acids. Thus, for example, the zinc salt of a saturated C₁₄-C₂₀ alkyl carboxylic acid can be a mixture comprising zinc octadecanoate and zinc hexadecanoate. In such an embodiment, the ratio of these two zinc salts can vary based on the relative abundance of octadecanoic acid and hexadecanoic acid in the acid source used to make the zinc salts. Preferably, when the zinc salt of a saturated C₁₄-C₂₀ alkyl carboxylic acid is a mixture comprising zinc octadecanoate and zinc hexadecanoate, zinc octadecanoate is the predominant zinc salt present in the mixture (i.e., zinc octadecanoate is greater than 50 mol. % of the mixture).

The additive composition comprises a layered double hydroxide mineral. The layered double hydroxide mineral preferably is selected from the group consisting of aluminum magnesium hydroxide carbonate, aluminum magnesium zinc hydroxide carbonate, and mixtures thereof. Preferably, the layered double hydroxide mineral has the formula [[(Mg²⁺)ₐ (Zn²⁺)_{b}]_{1-c} (Al³⁺)_{c} (OH)₂](CO₃²⁻)_{c/2}·nH₂O. In the formula for the layered double hydroxide mineral, the value of a is from 0 to 1 (i.e., 0≤a≤1), the value of b is from 0 to 1 (i.e., 0≤b≤1), the sum of a and b is from 0.5 to 1 (i.e., 0.5≤a+b≤1), the value of c is greater than 0 but no greater than 0.5 (i.e., 0<c≤0.5), and the value of n is from 0 to less than 2 (i.e., 0<n<2). In a preferred embodiment, the layered double hydroxide mineral is an aluminum magnesium hydroxide carbonate having the formula [(Mg²⁺)_{1-c} (Al³⁺)_{c} (OH)₂](CO₃²⁻)_{c/2}·nH₂O, where the value of c is greater than 0 but no greater than 0.5 (i.e., 0<c≤0.5), and the value of n is from 0 to less than 2 (i.e., 0≤n<2). In another preferred embodiment, the layered double hydroxide mineral is an aluminum magnesium hydroxide carbonate having the formula Mg₆Al₂(CO₃)(OH)₁₆·4H₂O.

In a preferred embodiment, the layered double hydroxide mineral can be at least partially coated with one or more saturated or unsaturated C₁₄-C₂₀ alkyl carboxylic acids (e.g., the layered double hydroxide mineral can be present in the additive composition in the form of particles the surfaces of which are at least partially coated with one or more such acids). Suitable saturated or unsaturated C₁₄-C₂₀ alkyl carboxylic acids include, but are not limited to, tetradecanoic acid, hexadecanoic acid, octadecanoic acid, (9Z)-octadec-9-enoic acid, and (9Z,12Z)-octadeca-9,12-dienoic acid. Preferably, the layered double hydroxide mineral is at least partially coated with octadecanoic acid. More preferably, the layered double hydroxide mineral is at least partially coated with octadecanoic acid and (9Z)-octadec-9-enoic acid. In yet another preferred embodiment, the layered double hydroxide mineral is at least partially coated with octadecanoic acid, (9Z)-octadec-9-enoic acid, and (9Z,12Z)-octadeca-9,12-dienoic acid. When coated with one or more C₁₄-C₂₀ alkyl carboxylic acids as described above, the layered double hydroxide mineral can be coated with up to 5 wt. % of the acid(s) (i.e., the acid(s) account for up to 5 wt. % of the combined mass of the layered double hydroxide mineral and the acid(s) coating the layered double hydroxide mineral), such as from about 0.1 wt. % to 5 wt. %.

The calcium salt of rel-(1R,2S)-cyclohexane-1,2-dicarboxylic acid, zinc salt of a saturated C₁₄-C₂₀ alkyl carboxylic acid, and layered double hydroxide mineral can be present in the additive composition in any suitable relative amounts. In a preferred embodiment, the ratio of the mass of the zinc salt of a saturated C₁₄-C₂₀ alkyl carboxylic acid present in the additive composition to the mass of the calcium salt of rel-(1R,2S)-cyclohexane-1,2-dicarboxylic acid present in the additive composition is about 1:3 to about 1:1. More preferably, the ratio of the mass of the zinc salt of a saturated C₁₄-C₂₀ alkyl carboxylic acid present in the additive composition to the mass of the calcium salt of rel-(1R,2S)-cyclohexane-1,2-dicarboxylic acid present in the additive composition is about 1:2. In another preferred embodiment, the ratio of the mass of the zinc salt of a saturated C₁₄-C₂₀ alkyl carboxylic acid present in the additive composition to the mass of the layered double hydroxide mineral present in the additive composition is about 1:10 to about 2:1. More preferably, the ratio of the mass of the zinc salt of a saturated C₁₄-C₂₀ alkyl carboxylic acid present in the additive composition to the mass of the layered double hydroxide mineral present in the additive composition is about 1:10 to about 1:1. In yet another preferred embodiment, the ratio of the mass of the zinc salt of a saturated C₁₄-C₂₀ alkyl carboxylic acid present in the additive composition to the mass of the layered double hydroxide mineral present in the additive composition is about 1:3 to about 1:1 (e.g., about 2:5 to about 3:4).

In another preferred embodiment, the ratio of the combined total mass of the zinc salt of a saturated C₁₄-C₂₀ alkyl carboxylic acid and the layered double hydroxide mineral present in the additive composition to the mass of the calcium salt of rel-(1R,2S)-cyclohexane-1,2-dicarboxylic acid present in the additive composition is about 3:4 to about 15:1. More preferably, the ratio of the combined total mass of the zinc salt of a saturated C₁₄-C₂₀ alkyl carboxylic acid and the layered double hydroxide mineral present in the additive composition to the mass of the calcium salt of rel-(1R,2S)-cyclohexane-1,2-dicarboxylic acid present in the additive composition is about 3:4 to about 2:1. In yet another preferred embodiment, the ratio of the combined total mass of the zinc salt of a saturated C₁₄-C₂₀ alkyl carboxylic acid and the layered double hydroxide mineral present in the additive composition to the mass of the calcium salt of rel-(1R,2S)-cyclohexane-1,2-dicarboxylic acid present in the additive composition is about 1:1 to about 2:1 (e.g., about 5:4 to about 7:4 or about 5:4 to about 3:2).

In another embodiment, the additive composition can comprise one or more pigments in addition to the components described above. In a preferred embodiment, the additive composition comprises a pigment selected from the group consisting of blue pigments, violet pigments, black pigments, and mixtures of two or more of the foregoing. Suitable blue pigments include, but are not limited to, C.I. Pigment Blue 29, C.I. Pigment Blue 15, C.I. Pigment Blue 63, and mixtures thereof. Suitable violet pigments include, but are not limited to, C.I. Pigment Violet 15. Suitable black pigments include, but are not limited, carbon black, C.I. Pigment Black 1, C.I. Pigment Black 11, C.I. Pigment Black 31, and mixtures thereof. In a preferred embodiment, the additive composition comprises a blue pigment and/or a violet pigment, and the blue pigment and/or violet pigment is a sulfur-containing aluminosilicate. In a preferred embodiment, the additive composition comprises a mixture of a blue pigment and a violet pigment, both of which preferably are sulfur-containing aluminosilicate pigments (e.g., a mixture of Pigment Blue 29 and Pigment Violet 15). In another preferred embodiment, the additive composition comprises a mixture of a blue pigment and a black pigment, preferably with the blue pigment being a sulfur-containing aluminosilicate pigment (e.g., a mixture of Pigment Blue 29 and carbon black). When present in the additive composition, the pigment(s) can account for about 1 wt. % to about 10 wt. % (more preferably about 2 wt. % to about 6 wt. %) of the combined total mass of calcium salt of rel-(1R,2S)-cyclohexane-1,2-dicarboxylic acid, zinc salt of a saturated C₁₄-C₂₀ alkyl carboxylic acid, layered double hydroxide mineral, and pigment(s) present in the additive composition.

The additive composition of the invention can contain other nucleating agents in addition to the calcium salt of rel-(1R,2S)-cyclohexane-1,2-dicarboxylic acid described above. Suitable nucleating agents include, but are not limited to, 2,2′-methylene-bis-(4,6-di-tert-butylphenyl) phosphate salts (e.g., sodium 2,2′-methylene-bis-(4,6-di-tert-butylphenyl) phosphate or hydroxyaluminum bis(2,2′-methylene-bis-(4,6-di-tert-butylphenyl)phosphate), bicyclo[2.2.1]heptane-2,3-dicarboxylate salts (e.g., disodium bicyclo[2.2.1]heptane-2,3-dicarboxylate or calcium bicyclo[2.2.1]heptane-2,3-dicarboxylate), cyclohexane-1,2-dicarboxylate salts (e.g., calcium cyclohexane-1,2-dicarboxylate, monobasic aluminum cyclohexane-1,2-dicarboxylate, dilithium cyclohexane-1,2-dicarboxylate, or strontium cyclohexane-1,2-dicarboxylate), glycerolate salts (e.g., zinc glycerolate), phthalate salts (e.g., calcium phthalate), phenylphosphonic acid salts (e.g., calcium phenylphosphonate), and combinations thereof. For the bicyclo[2.2.1]heptane-2,3-dicarboxylate salts and the cyclohexane-1,2-dicarboxylate salts, the carboxylate moieties can be arranged in either the cis- or trans-configuration, with the cis-configuration being preferred. In a preferred embodiment, the additive composition further comprises a bicyclo[2.2.1]heptane-2,3-dicarboxylate salt, such as disodium bicyclo[2.2.1]heptane-2,3-dicarboxylate and/or calcium bicyclo[2.2.1]heptane-2,3-dicarboxylate.

In some embodiments, the additive composition can also contain a clarifying agent. Suitable clarifying agents include, but are not limited to, trisamides, acetal compounds that are the condensation product of a polyhydric alcohol and an aromatic aldehyde, and triazine derivatives. Suitable trisamide clarifying agents include, but are not limited to, amide derivatives of benzene-1,3,5-tricarboxylic acid, derivatives of N-(3,5-bis-formylamino-phenyl)-formamide (e.g., N-[3,5-bis-(2,2-dimethyl-propionylamino)-phenyl]-2,2-dimethyl-propionamide), derivatives of 2-carbamoyl-malonamide (e.g., N,N′-bis-(2-methyl-cyclohexyl)-2-(2-methyl-cyclohexylcarbamoyl)-malonamide), and combinations thereof. As noted above, the clarifying agent can be an acetal compound that is the condensation product of a polyhydric alcohol and an aromatic aldehyde. Suitable polyhydric alcohols include acyclic polyols such as xylitol and sorbitol, as well as acyclic deoxy polyols (e.g., 1,2,3-trideoxynonitol or 1,2,3-trideoxynon-1-enitol). Suitable aromatic aldehydes typically contain a single aldehyde group with the remaining positions on the aromatic ring being either unsubstituted or substituted. Accordingly, suitable aromatic aldehydes include benzaldehyde and substituted benzaldehydes (e.g., 3,4-dimethyl-benzaldehyde or 4-propyl-benzaldehyde). The acetal compound produced by the aforementioned reaction can be a mono-acetal, di-acetal, or tri-acetal compound (i.e., a compound containing one, two, or three acetal groups, respectively), with the di-acetal compounds being preferred. Suitable acetal-based clarifying agents include, but are not limited to, the clarifying agents disclosed in U.S. Pat. Nos. 5,049,605; 7,157,510; and 7,262,236. Suitable triazine derivative clarifiers include, but are not limited to, the derivatives disclosed in US 2021/0395209, US 2023/0312876, WO 2025/013891 A1. In a preferred embodiment, the triazine derivative clarifying agent is a reaction product of 2,4,6-trichloro-1,3,5-triazine, [1,1′-Biphenyl]-4,4′-diol, and 4-cyclohexylphenol (CAS Reg. No. 2561414-35-3).

In a second embodiment, the invention provides a polymer composition comprising a polypropylene polymer and the additive composition described above. The polymer composition can comprise any suitable polypropylene polymer. In a preferred embodiment, the polypropylene polymer is selected from the group consisting of polypropylene homopolymers (e.g., atactic polypropylene homopolymer, isotactic polypropylene homopolymer, and syndiotactic polypropylene homopolymer), polypropylene copolymers (e.g., polypropylene random copolymers), polypropylene impact copolymers, and mixtures thereof. Suitable polypropylene copolymers include, but are not limited to, random copolymers made from the polymerization of propylene in the presence of a comonomer selected from the group consisting of ethylene, but-1-ene (i.e., 1-butene), and hex-1-ene (i.e., 1-hexene), with ethylene being particularly preferred. In such polypropylene random copolymers, the comonomer can be present in any suitable amount, but typically is present in an amount of less than about 10 wt. % (e.g., about 0.5 wt. % to about 10 wt. %, or about 1 wt. % to about 7 wt. %). Suitable polypropylene impact copolymers include, but are not limited to, those produced by the addition of a copolymer selected from the group consisting of ethylene-propylene rubber (EPR), ethylenepropylene-diene monomer (EPDM), polyethylene, and plastomers to a polypropylene homopolymer or polypropylene random copolymer. In such polypropylene impact copolymers, the copolymer can be present in any suitable amount, but typically is present in an amount of from about 5 to about 25 wt. %. Suitable polypropylene impact copolymers also include, but are not limited to, copolymers made by the polymerization of propylene and ethylene using one or more Zeigler Natta catalysts. Such polypropylene impact copolymers generally have a heterophasic structure in which an amorphous ethylene-propylene copolymer is dispersed in a semi-crystalline polypropylene homopolymer or copolymer matrix. The polypropylene polymers described above can be branched or cross-linked, such as the branching or cross-linking that results from the addition of additives that increase the melt strength of the polymer. In a preferred embodiment, the polypropylene polymer is a polypropylene homopolymer (e.g., an isotactic polypropylene homopolymer).

The polypropylene polymer can have any suitable melt flow rate. Preferably, the polypropylene polymer has a melt flow rate of 10 g/10 min or more. In another preferred embodiment, the polypropylene polymer has a melt flow rate of about 25 g/10 min or more. In another preferred embodiment, the polypropylene polymer has a melt flow rate of about 50 g/10 min or more. In yet another preferred embodiment, the polypropylene polymer has a melt flow rate of about 60 g/10 min or more. Generally, the melt flow rate of the polypropylene polymer is less than 100 g/10 min. Thus, in a series of preferred embodiments, the polypropylene polymer has a melt flow rate of about 10 g/10 min to about 100 g/10 min, about 25 g/10 min to about 100 g/10 min, about 50 g/10 min to about 100 g/10 min, or about 60 g/10 min to about 100 g/10 min. The melt flow rate of the polypropylene polymer can be measured by any suitable method, such as ASTM D1238 at 230° C. with a 2.16 kg load. Preferably, the melt flow rates of the polypropylene described above are measured in accordance with ASTM D1238 at 230° C. with a 2.16 kg load. Preferably, the polypropylene polymer is not modified with a peroxide or similar vis-breaking agent to yield the melt flow rates described above. Such unmodified polypropylene polymers are generally referred to as “reactor grade” polymers, which name refers to the fact that the polypropylene polymer discharged from the polymerization reactor did not require further modification to achieve the target or reported melt flow rate.

The polypropylene polymer preferably has a relatively low amorphous content and, consequently, relatively high crystallinity. The amorphous content of the polypropylene polymer can be measured by extraction using various solvents and various techniques. The portion of the polypropylene polymer that is extracted by the solvent is referred to as the “soluble fraction,” and the amount of the soluble fraction correlates to the amorphous content of the polypropylene polymer. Preferably, the polypropylene polymer has a soluble fraction of about 4 wt. % or less (e.g., 0.01 wt. % to about 4 wt. %). In another preferred embodiment, the polypropylene polymer has a soluble fraction of about 3.5 wt. % or less (e.g., 0.01 wt. % to about 3.5 wt. %) or about 3 wt. % or less (e.g., about 0.01 wt. % to about 3 wt. %). The soluble fraction of the polypropylene polymer, which is expressed as a weight percentage (wt. %) of the polypropylene polymer, preferably is measured using a Crystex® 42 analyzer (from Polymer Char, Valencia, Spain) and 1,2,4-trichlorobenzene stabilized with 300 ppm of pentaerythritol tetrakis(3-(3,5-di-tert-butyl-4-hydroxyphenyl)propionate) as the solvent. The additional parameters preferably used when analyzing the polymer using the Crystex® 42 analyzer are as follows. A 160 mg sample of the polymer is dissolved in 16 mL of the described solvent. The sample volume injected into the analyzer is 0.3 mL. The dissolution temperature is set to 160° C., the crystallization temperature is set to 40° C., and the analysis temperature is set to 165° C. The dissolution time is 90 min, with stirring set to high. The crystallization time is 40 min.

The polymer composition can contain any suitable amount of the additive composition. Generally, the additive composition is added to the polypropylene polymer in an amount designed to yield a desired concentration of one or more of the additive composition components in the polymer composition. For example, the additive composition can be added to yield a desired concentration of the calcium salt of rel-(1R,2S)-cyclohexane-1,2-dicarboxylic acid in the polymer composition. Thus, in a preferred embodiment, the additive composition is added so that the calcium salt of rel-(1R,2S)-cyclohexane-1,2-dicarboxylic acid is present in the polymer composition in an amount of about 100 ppm or more, based on the total weight of the polymer composition. In another preferred embodiment, the additive composition is added so that the calcium salt of rel-(1R,2S)-cyclohexane-1,2-dicarboxylic acid is present in the polymer composition in an amount of about 150 ppm or more, based on the total weight of the polymer composition. The amount of the calcium salt of rel-(1R,2S)-cyclohexane-1,2-dicarboxylic acid present in the polymer composition preferably is about 1,000 ppm or less (e.g., about 750 ppm or less or about 500 ppm or less), based on the total weight of the polymer composition. Thus, in a series of preferred embodiment, the additive composition is added so that the calcium salt of rel-(1R,2S)-cyclohexane-1,2-dicarboxylic acid is present in the polymer composition in an amount of about 100 ppm to about 1,000 ppm (e.g., about 100 ppm to about 750 ppm or about 100 ppm to about 500 ppm) or about 150 ppm to about 1,000 ppm (e.g., about 150 ppm to about 750 ppm or about 150 ppm to about 500 ppm), based on the total weight of the polymer composition. If the additive composition (and polymer composition) comprises more than one calcium salt of rel-(1R,2S)-cyclohexane-1,2-dicarboxylic acid, each calcium salt of rel-(1R,2S)-cyclohexane-1,2-dicarboxylic acid can be present in the polymer composition in one of the amounts recited above, or the combined amount of all calcium salts of rel-(1R,2S)-cyclohexane-1,2-dicarboxylic acid present in the polymer composition can fall within one of the ranges recited above. Preferably, when the additive composition (and polymer composition) comprises more than one calcium salt of rel-(1R,2S)-cyclohexane-1,2-dicarboxylic acid, the combined amount of all calcium salts of rel-(1R,2S)-cyclohexane-1,2-dicarboxylic acid present in the polymer composition falls within one of the ranges recited above.

In another embodiment, the additive composition additive composition is added so that the layered double hydroxide mineral is present in the polymer composition in an amount of about 100 ppm or more, based on the total weight of the polymer composition. In another preferred embodiment, the additive composition is added so that the layered double hydroxide mineral is present in the polymer composition in an amount of about 150 ppm or more, based on the total weight of the polymer composition. The amount of the layered double hydroxide mineral present in the polymer composition preferably is about 1,000 ppm or less (e.g., about 750 ppm or less, about 500 ppm or less, or about 400 ppm or less), based on the total weight of the polymer composition. Thus, in a series of preferred embodiment, the additive composition is added so that the layered double hydroxide mineral is present in the polymer composition in an amount of about 100 ppm to about 1,000 ppm (e.g., about 100 ppm to about 750 ppm, about 100 ppm to about 500 ppm, or about 100 ppm to about 400 ppm) or about 150 ppm to about 1,000 ppm (e.g., about 150 ppm to about 750 ppm, about 150 ppm to about 500 ppm, or about 150 ppm to about 400 ppm), based on the total weight of the polymer composition. If the additive composition (and polymer composition) comprises more than one layered double hydroxide mineral, each layered double hydroxide mineral can be present in the polymer composition in one of the amounts recited above, or the combined amount of all layered double hydroxide minerals present in the polymer composition can fall within one of the ranges recited above. Preferably, when the additive composition (and polymer composition) comprises more than one layered double hydroxide mineral, the combined amount of all layered double hydroxide minerals present in the polymer composition falls within one of the ranges recited above.

The polymer composition of the invention can contain other polymer additives in addition to the components present in the additive composition described above. Suitable additional polymer additives include, but are not limited to, antioxidants (e.g., phenolic antioxidants, phosphite antioxidants, and combinations thereof), anti-blocking agents (e.g., amorphous silica and diatomaceous earth), pigments (e.g., organic pigments and inorganic pigments) and other colorants (e.g., dyes and polymeric colorants), fillers and reinforcing agents (e.g., glass, glass fibers, talc, calcium carbonate, and magnesium oxysulfate whiskers), nucleating agents, clarifying agents, acid scavengers (e.g., metal salts of fatty acids, such as the metal salts of stearic acid, and hydrotalcite-like materials), polymer processing additives (e.g., fluoropolymer polymer processing additives), polymer cross-linking agents, slip agents (e.g., fatty acid amide compounds derived from the reaction between a fatty acid and ammonia or an amine-containing compound), fatty acid ester compounds (e.g., fatty acid ester compounds derived from the reaction between a fatty acid and a hydroxyl-containing compound, such as glycerol, diglycerol, and combinations thereof), polymer modifiers (e.g., hydrocarbon resin modifiers such as those sold under the Oppera™ tradename by Exxon Mobil Corporation), and combinations of the foregoing.

The polymer composition of the invention can be produced by any suitable method or process. For example, the polymer composition can be produced by simple mixing of the polypropylene polymer and the additive composition. Alternatively, the polymer composition can be produced by simple mixing of the individual components of the desired polymer composition, such as the polypropylene polymer, the calcium salt of rel-(1R,2S)-cyclohexane-1,2-dicarboxylic acid, the zinc salt of a saturated C₁₄-C₂₀ alkyl carboxylic acid, and the layered double hydroxide mineral. The polymer composition can also be produced by mixing the components as described above under high shear or high intensity mixing conditions. The polymer composition of the invention can be provided in any form suitable for use in further processing to produce an article of manufacture from the thermoplastic polymer composition. For example, the thermoplastic polymer compositions can be provided in the form of a powder (e.g., free-flowing powder), flake, pellet, prill, tablet, agglomerate, and the like.

The polymer composition of the invention can take the form of a masterbatch composition designed for addition or let-down into a virgin polymer (e.g., an unnucleated polypropylene polymer). In such an embodiment, the polymer composition will generally contain a higher amount of, for example, the calcium salt of rel-(1R,2S)-cyclohexane-1,2-dicarboxylic acid as compared to a polymer composition intended for use in the formation of an article of manufacture without further dilution or addition to a virgin polymer. For example, the calcium salt of rel-(1R,2S)-cyclohexane-1,2-dicarboxylic acid can be present in such a masterbatch polymer composition in an amount of about 0.5 wt. % or more (e.g., about 1 wt. % or more or about 2 wt. % or more). The maximum amount of the salt in the masterbatch is only limited by manufacturing and processing considerations, though the amount would typically be about 50 wt. % or less. Thus, in a series of preferred embodiments of such a masterbatch, the calcium salt of rel-(1R,2S)-cyclohexane-1,2-dicarboxylic acid can be present in the masterbatch polymer composition in an amount of about 0.5 wt. % to about 50 wt. % (e.g., about 0.5 wt. % to about 40 wt. %, about 0.5 wt. % to about 30 wt. %, about 0.5 wt. % to about 25 wt. %, about 0.5 wt. % to about 20 wt. %, about 0.5 wt. % to about 15 wt. %, about 0.5 wt. % to about 10 wt. %, about 0.5 wt. % to about 5 wt. %, or about 0.5 wt. % to about 4 wt. %), about 1 wt. % to about 50 wt. % (e.g., about 1 wt. % to about 40 wt. %, about 1 wt. % to about 30 wt. %, about 1 wt. % to about 25 wt. %, about 1 wt. % to about 20 wt. %, about 1 wt. % to about 15 wt. %, about 1 wt. % to about 10 wt. %, about 1 wt. % to about 5 wt. %, or about 1 wt. % to about 4 wt. %), or about 2 wt. % to about 50 wt. % (e.g., about 2 wt. % to about 40 wt. %, about 2 wt. % to about 30 wt. %, about 2 wt. % to about 25 wt. %, about 2 wt. % to about 20 wt. %, about 2 wt. % to about 15 wt. %, about 2 wt. % to about 10 wt. %, about 2 wt. % to about 5 wt. %, or about 2 wt. % to about 4 wt. %), based on the total weight of the polymer composition. In such a masterbatch composition, the additional components contained in the additive composition will likewise be present in higher amounts that are intended to deliver the desired concentration when the masterbatch composition is let-down in the virgin polymer.

The polymer composition of the invention is believed to be useful in producing thermoplastic polymer articles of manufacture. The polymer composition of the invention can be formed into a desired thermoplastic polymer article of manufacture by any suitable technique, such as injection molding (e.g., thin-wall injection molding, multicomponent molding, overmolding, or 2K molding), blow molding (e.g., extrusion blow molding, injection blow molding, or injection stretch blow molding), extrusion (e.g., fiber extrusion, tape (e.g., slit tape) extrusion, sheet extrusion, film extrusion, cast film extrusion, pipe extrusion, extrusion coating, or foam extrusion), thermoforming, rotomolding, film blowing (blown film), film casting (cast film), compression molding, extrusion compression molding, extrusion compression blow molding, and the like. Thermoplastic polymer articles made using the polymer composition of the invention can be comprised of multiple layers (e.g., multilayer blown or cast films or multilayer injection molded articles), with one or any suitable number of the multiple layers containing a polymer composition of the invention.

The polymer composition of the invention can be used to produce any suitable article of manufacture. Suitable articles of manufacture include, but are not limited to, medical devices (e.g., pre-filled syringes for retort applications, intravenous supply containers, and blood collection apparatus), food packaging, liquid containers (e.g., containers for drinks, medications, personal care compositions, shampoos, and the like), apparel cases, microwavable articles, shelving, cabinet doors, mechanical parts, automobile parts, sheets, pipes, tubes, rotationally molded parts, blow molded parts, films, fibers, and the like.

The polymer composition described above and molded articles produced from the polymer composition are believed to exhibit a desirable combination of physical properties. For example, the polymer composition described above preferably exhibits a relatively high polymer crystallization temperature. The polymer composition described above preferably exhibits a peak polymer recrystallization temperature greater than 120° C. (e.g., about 120° C. to about 130° C.), more preferably about 122° C. or greater (e.g., about 122° C. to about 130° C.). (The peak polymer recrystallization temperature can be determined using differential scanning calorimetry, with the preferred method being described in Example 1 below). The polymer composition described above also exhibits relatively rapid crystallization kinetics, as indicated by a relatively low crystallization half-time. The polymer composition described above preferably exhibits a crystallization half-time less than 4 minutes (e.g., about 0.5 minutes to 4 minutes, or about 1 minute to 4 minutes), more preferably less than about 3.5 minutes (e.g., about 0.5 minutes to about 3.5 minutes, or about 1 minute to about 3.5 minutes) and even more preferably less than about 3.25 minutes (e.g., about 0.5 minutes to about 3.25 minutes, or about 1 minute to about 3.25 minutes).

Additionally, articles made from the polymer composition generally exhibit desirably low haze levels. In particular, for a polymer composition having a melt flow rate of about 50 g/10 min or more (e.g., about 50 g/10 min to about 100 g/10 min), a 30 mil (0.762 mm) plaque made from the polymer composition typically exhibits a haze of less than about 40% (e.g., about 1% to about 40%, about 10% to about 40%, or about 20% to about 40%). In those embodiments in which the polypropylene polymer is a reactor grade polymer having a melt flow rate of about 50 g/10 min or more (e.g., about 50 g/10 min to about 100 g/10 min), a 30 mil (0.762 mm) plaque made from the polymer composition typically exhibits a haze of less than about 30% (e.g., about 1% to about 30%, about 10% to about 30%, or about 20% to about 30%). (The foregoing haze measurements preferably are determined in accordance with ASTM D1003.)

The polymer composition described above and articles made from it also generally exhibit desirable levels of stiffness. The stiffness can be measured and quantified by any suitable standard, but preferably the stiffness is determined by measuring the chord modulus in accordance with ISO 178 standard method (and the values reported below preferably are determined in accordance with this method). For example, the polymer composition generally exhibits a chord modulus of about 1,450 MPa or more (e.g., about 1,450 MPa to about 3,000 MPa, or about 1,450 MPa to about 2,500 MPa). In those embodiments in which the polypropylene polymer is a reactor grade polymer, the polymer composition preferably exhibits a chord modulus of about 1,550 MPa or more (e.g., about 1,550 MPa to about 3,000 MPa, or about 1,550 MPa to about 2,500 MPa). Indeed, some embodiments made utilizing reactor grade polypropylene homopolymers can exhibit a chord modulus in excess of 2,000 MPa (e.g., about 2,000 MPa to about 3,000 MPa, or about 2,000 MPa to about 2,500 MPa).

The following examples further illustrate the subject matter described above but, of course, should not be construed as in any way limiting the scope thereof.

### Example 1

This example demonstrates the production of polymer compositions according to the invention and certain physical properties of molded parts made with such polymer compositions.

Polymer compositions were prepared by weighing the noted amounts of additives into 3 kg batches of polypropylene homopolymer powder, high intensity mixing the combined ingredients, and extruding the resulting mixture into pellets on a single screw extruder. Table 1 sets forth the amount of each additive contained in each polymer composition. Samples 1A-1L were made with a reactor grade polypropylene homopolymer having an initial melt flow rate of 12 g/10 min (Pro-fax 6301 polypropylene homopolymer from LyondellBasell, designated as “HPP6301” in Table 1). Samples 1F-1L were modified with a peroxide as noted in Table 1 below to have a melt flow rate of approximately 65 g/10 min. Samples 1M-1U were made with a reactor grade polypropylene homopolymer having a melt flow rate of 70 g/10 min (“Resin C”). In Table 1, “N.A. 1” is anhydrous calcium rel-(1R,2S)-cyclohexane-1,2-dicarboxylate, and “N.A. 2” is calcium rel-(1R,2S)-cyclohexane-1,2-dicarboxylate monohydrate. “ZnOcta” is zinc octadecanoate, and “CaOcta” is calcium octadecanoate. “LDHM 1” is a commercially available aluminum magnesium hydroxide carbonate (DHT-4V™ from Kisuma Chemicals). The peroxide is 2,5-dimethyl-2,5-di(t-butylperoxy)hexane (Varox DBPH from Vanderbilt Chemicals, LLC). Each polymer composition also contained 500 ppm of Irganox® 1010 (BASF) and 1,000 ppm of Irgafos® 168 secondary antioxidant (BASF).

TABLE 1

| | | N.A. 1 | N.A. 2 | ZnOcta | CaOcta | LDHM 1 | Peroxide |
|---|---|---|---|---|---|---|---|
| Sample | Resin | (ppm) | (ppm) | (ppm) | (ppm) | (ppm) | (ppm) |
| 1A | HPP6301 | | | | 600 | | |
| 1B | HPP6301 | 335 | | 165 | 600 | | |
| 1C | HPP6301 | 665 | | 335 | 600 | | |
| 1D | HPP6301 | 335 | | 165 | | 300 | |
| 1E | HPP6301 | 665 | | 335 | | 300 | |
| 1F | HPP6301 | | | | 600 | | 455 |
| 1G | HPP6301 | 335 | | 165 | 600 | | 455 |
| 1H | HPP6301 | 665 | | 335 | 600 | | 455 |
| 1I | HPP6301 | 335 | | 165 | | 300 | 455 |
| 1J | HPP6301 | 665 | | 335 | | 300 | 455 |
| 1K | HPP6301 | | 335 | 165 | 600 | | 455 |
| 1L | HPP6301 | | 335 | 165 | | 300 | 455 |
| 1M | Resin C | | | | 600 | | |
| 1N | Resin C | 335 | | 165 | 600 | | |
| 1O | Resin C | 665 | | 335 | 600 | | |
| 1P | Resin C | 335 | | 165 | | 300 | |
| 1Q | Resin C | 665 | | 335 | | 300 | |
| 1R | Resin C | | 335 | 165 | 600 | | |
| 1S | Resin C | | 665 | 335 | 600 | | |
| 1T | Resin C | | 335 | 165 | | 300 | |
| 1U | Resin C | | 665 | 335 | | 300 | |

The polymer compositions were compounded on a DeltaPlast single screw extruder. The barrel temperature of the extruder was ramped from 200 to 230° C. and the screw speed was set at approximately 130 rpm. A portion of each polymer composition was used to produce bars through injection molding on an Arburg 40 ton injection molder. The molder was set at a temperature between 190° C. and 260° C. The injection speed was 14 cm³/sec. The bars had dimensions of about 80 mm×10 mm×4 mm.

The polymer compositions were evaluated for peak polymer recrystallization temperature, % haze in accordance with ASTM Standard 01003 (30-mil plaques), and chord modulus in accordance with ISO Standard 178. The results of these measurements are reported in Table 2 below. The peak polymer crystallization temperature (T_{c}) was determined using a differential scanning calorimeter (Mettler-Toledo DSC822 differential scanning calorimeter). This was accomplished by heating an approximately 5 milligram sample at 20° C./minute from 50° C. to 220° C., holding temperature at 220° C. for 2 minutes to remove any thermal history, and cooling the sample at a rate of 20° C./minute down to 50° C. The peak of the crystallization exotherm was recorded as peak polymer recrystallization temperature (Tc).

The melt flow rate (MFR) was determined on the pelletized compositions according to ASTM 01238 at 230° C. with a load of 2.16 kg for polypropylene.

The flexural property was measured in accordance with ISO 178 standard method using the bars described above after 4 days of annealing at room temperature. Measurements were carried out at 2 mm/minute speed on a 64 mm support span, and support span to specimen depth ratio of 16:1 mm/mm. The reported values are averages of five measurements.

TABLE 2

| | MFR | chord Modulus | 30 mil Haze | T_{c} |
|---|---|---|---|---|
| Sample | (g/10 min) | (MPa) | (%) | (° C.) |
| 1A | 12 | 1376.7 | 27.2 | 118.2 |
| 1B | 12 | 1563.4 | 17.6 | 122.8 |
| 1C | 12 | 1569.7 | 17 | 123.8 |
| 1D | 12 | 1562.7 | 16.5 | 126.3 |
| 1E | 12 | 1579.3 | 15.9 | 126.7 |
| 1F | 65 | 1319.4 | 56.2 | 118.8 |
| 1G | 65 | 1486.1 | 41.1 | 123.2 |
| 1H | 65 | 1504.6 | 40.3 | 124.0 |
| 1I | 65 | 1517.9 | 34.8 | 124.2 |
| 1J | 65 | 1532.7 | 35.4 | 124.2 |
| 1K | 65 | 1437.8 | 43.4 | 121.2 |
| 1L | 65 | 1481.9 | 38.9 | 122.0 |
| 1M | 70 | 1675.9 | 31.6 | 118.5 |
| 1N | 70 | 1950.5 | 35.9 | 123.5 |
| 1O | 70 | 1959.9 | 30.1 | 124.3 |
| 1P | 70 | 2040.9 | 22.5 | 126.2 |
| 1Q | 70 | 2058.1 | 22.3 | 126.7 |
| 1R | 70 | 1926.5 | 36.4 | 123.2 |
| 1S | 70 | 1976.5 | 32.8 | 124.2 |
| 1T | 70 | 2075.2 | 24.6 | 125.7 |
| 1U | 70 | 2101.3 | 23.7 | 125.8 |

As can be seen from the data in Table 2, the polymer compositions containing a calcium salt of rel-(1R,2S)-cyclohexane-1,2-dicarboxylic acid, a zinc salt of a saturated C₁₄-C₂₀ alkyl carboxylic acid (e.g., zinc octadecanoate), and a layered double hydroxide mineral all exhibited improved chord modulus, haze, and peak polymer recrystallization temperature relative to the comparable unnucleated resin (having the same melt flow rate) as well as the comparable polymer compositions containing a calcium salt of rel-(1R,2S)-cyclohexane-1,2-dicarboxylic acid, zinc octadecanoate, and calcium octadecanoate.

### Example 2

This example demonstrates the production of polymer compositions according to the invention and certain physical properties of thin-wall injection molded parts made with such polymer compositions.

Polymer compositions were prepared by weighing the noted amounts of additives into 3 kg batches of polypropylene homopolymer powder, high intensity mixing the combined ingredients, and extruding the resulting mixture into pellets on a single screw extruder. Table 3 sets forth the amount of each additive contained in each polymer composition. Samples 2A-2J were made with a reactor grade polypropylene homopolymer having an initial melt flow rate of 12 g/10 min (Pro-fax 6301 polypropylene homopolymer from LyondellBasell, designated as “HPP6301” in Table 3). Samples 2F-2J were modified with a peroxide as noted in Table 3 below to have a melt flow rate of approximately 65 g/10 min. Samples 2K-20 were made with a polypropylene homopolymer having an initial melt flow rate of 3.7 g/10 min (Pro-fax 6601 polypropylene homopolymer from LyondellBasell) that was modified with a peroxide to yield a melt flow rate of approximately 65 g/10 min (designated as “HPP6601” in Table 3). Samples 2P-2T were made with a reactor grade polypropylene homopolymer having a melt flow rate of 60 g/10 min (“Resin A”). Samples 2U-2Y were made with a reactor grade polypropylene homopolymer having a melt flow rate of 70 g/10 ml (“Resin B”). Samples 2Z-200 were made with a reactor grade polypropylene homopolymer having a melt flow rate of 70 g/10 min (“Resin C”). Samples 2EE-211 were made with a reactor grade polypropylene homopolymer having a melt flow rate of 80 g/10 min (“Resin 0”). In Table 3, “N.A. 1” is anhydrous calcium rel-(1R,2S)-cyclohexane-1,2-dicarboxylate. “ZnOcta” is zinc octadecanoate, and “CaOcta” is calcium octadecanoate. “LDHM 1” is a commercially available aluminum magnesium hydroxide carbonate (DHT-4V™ from Kisuma Chemicals). The peroxide is 2,5-dimethyl-2,5-di(t-butylperoxy)hexane (Varox DBPH from Vanderbilt Chemicals, LLC). Each polymer composition also contained 500 ppm of Irganox® 1010 (BASF) and 1,000 ppm of Irgafos® 168 secondary antioxidant (BASF).

TABLE 3

| | | N.A. 1 | ZnOcta | CaOcta | LDHM 1 | Peroxide |
|---|---|---|---|---|---|---|
| Sample | Resin | (ppm) | (ppm) | (ppm) | (ppm) | (ppm) |
| 2A | HPP6301 | | | 600 | | |
| 2B | HPP6301 | 333 | 167 | 600 | | |
| 2C | HPP6301 | 667 | 333 | 600 | | |
| 2D | HPP6301 | 333 | 167 | | 300 | |
| 2E | HPP6301 | 667 | 333 | | 300 | |
| 2F | HPP6301 | | | 600 | | 455 |
| 2G | HPP6301 | 333 | 167 | 600 | | 455 |
| 2H | HPP6301 | 667 | 333 | 600 | | 455 |
| 2I | HPP6301 | 333 | 167 | | 300 | 455 |
| 2J | HPP6301 | 667 | 333 | | 300 | 455 |
| 2K | HPP6601 | | | 600 | | 1050 |
| 2L | HPP6601 | 333 | 167 | 600 | | 1050 |
| 2M | HPP6601 | 667 | 333 | 600 | | 1050 |
| 2N | HPP6601 | 333 | 167 | | 300 | 1050 |
| 2O | HPP6601 | 667 | 333 | | 300 | 1050 |
| 2P | Resin A | | | 600 | | |
| 2Q | Resin A | 333 | 167 | 600 | | |
| 2R | Resin A | 667 | 333 | 600 | | |
| 2S | Resin A | 333 | 167 | | 300 | |
| 2T | Resin A | 667 | 333 | | 300 | |
| 2U | Resin B | | | 600 | | |
| 2V | Resin B | 333 | 167 | 600 | | |
| 2W | Resin B | 667 | 333 | 600 | | |
| 2X | Resin B | 333 | 167 | | 300 | |
| 2Y | Resin B | 667 | 333 | | 300 | |
| 2Z | Resin C | | | 500 | | |
| 2AA | Resin C | 333 | 167 | 500 | | |
| 2BB | Resin C | 667 | 333 | 500 | | |
| 2CC | Resin C | 333 | 167 | | 300 | |
| 2DD | Resin C | 667 | 333 | | 300 | |
| 2EE | Resin D | | | 600 | | |
| 2FF | Resin D | 333 | 167 | 600 | | |
| 2GG | Resin D | 667 | 333 | 600 | | |
| 2HH | Resin D | 333 | 167 | | 300 | |
| 2II | Resin D | 667 | 333 | | 300 | |

The polymer compositions were compounded on a DeltaPlast single screw extruder. The barrel temperature of the extruder was ramped from 200 to 230° C. and the screw speed was set at approximate 130 rpm. The extruded pellets of each polymer composition were then injection molded into 16 U.S. fluid ounce (470 mL) deli cups on a Husky injection molding machine with all barrels set at 220° C., an injection rate of 140 min/s, a back pressure of 50 psi (0.14 MPa), and the mold cooling water set at 45° C. The deli cups had a circular base measuring 3.637 inches (92.38 mm) in diameter, a height of 3 inches (76.2 mm), and a circular open at the top having a rim measuring 4.266 inches (108.4 mm) in diameter at the inner edge of the rim and 4.612 inches (117.1 mm) in diameter at the outer edge of the rim. The deli cups had a wall thickness of 26 mil (0.66 mm).

After molding, the deli cups were then tested to determine several physical properties. The compression top load was measured in accordance with ASTM 02659. The haze was measured in accordance with ASTM 01003. The crystallization behavior, specifically the crystallization half-time (t-1/2) and peak polymer recrystallization temperature (T_{c}), were measured using differential scanning calorimetry. The crystallization half-time was measured at 140° C., and the peak polymer recrystallization temperature was measured at a heating rate of 20° C./min as described in Example 1.

The soluble fraction of each polymer was measured using a Crystex® 42 analyzer (Polymer Char, Valencia, Spain) and 1,2,4-trichlorobenzene stabilized with 300 ppm of pentaerythritol tetrakis (3-(3,5-di-tert-butyl-4-hydroxyphenyl)propionate). A 160 mg sample of the polymer was dissolved in 16 mL of solvent. The sample volume injected into the analyzer was 0.3 mL. The dissolution temperature was 160° C., the crystallization temperature was 40° C., and the analysis temperature was 165° C. The dissolution time was 90 min, with stirring set to high. The crystallization time was 40 min.

The results of the above-described measurements are set forth in Table 4 below.

TABLE 4

| | Soluble | MFR | | | Top | |
|---|---|---|---|---|---|---|
| | Fraction | (g/10 | t-½ | T_{c} | Load | Haze |
| Sample | (wt. %) | min) | (mins) | (° C.) | (N) | (%) |
| 2A | 4.43 | 12 | 8.76 | 119.3 | 1119.4 | 33.2 |
| 2B | 4.43 | 12 | 4.41 | 123.3 | 1287.8 | 18.7 |
| 2C | 4.43 | 12 | 3.73 | 123.8 | 1337.2 | 16.6 |
| 2D | 4.43 | 12 | 3.05 | 124.8 | 1304.4 | 16.8 |
| 2E | 4.43 | 12 | 2.48 | 125.2 | 1339.2 | 16.3 |
| 2F | 5.61 | 65 | 7.03 | 121.0 | 1016.7 | 45.3 |
| 2G | 5.61 | 65 | 3.28 | 125.5 | 1142.7 | 28.9 |
| 2H | 5.61 | 65 | 2.69 | 126.0 | 1141.6 | 26.7 |
| 2I | 5.61 | 65 | 2.58 | 126.0 | 1154.8 | 23.6 |
| 2J | 5.61 | 65 | 2.37 | 126.8 | 1146.7 | 20.6 |
| 2K | 4.69 | 70 | 8.97 | 119.5 | 986.6 | 37.1 |
| 2L | 4.69 | 70 | 3.98 | 124.2 | 1161.7 | 28.5 |
| 2M | 4.69 | 70 | 3.31 | 124.8 | 1267.0 | 24 |
| 2N | 4.69 | 70 | 3.01 | 125.2 | 1170.6 | 27.1 |
| 2O | 4.69 | 70 | 2.88 | 125.5 | 1257.0 | 25.1 |
| 2P | 3.88 | 60 | 14.48 | 118.8 | 1187.4 | 45.5 |
| 2Q | 3.88 | 60 | 4.69 | 123.8 | 1203.8 | 33.5 |
| 2R | 3.88 | 60 | 3.80 | 124.2 | 1468.5 | 32.9 |
| 2S | 3.88 | 60 | 2.58 | 126.2 | 1347.4 | 25.9 |
| 2T | 3.88 | 60 | 2.23 | 126.7 | 1458.4 | 22.3 |
| 2U | 2.89 | 70 | 9.15 | 121.2 | 1220.3 | 46.2 |
| 2V | 2.89 | 70 | 2.95 | 126.2 | 1539.0 | 33.1 |
| 2W | 2.89 | 70 | 2.15 | 127.3 | 1570.3 | 28.9 |
| 2X | 2.89 | 70 | 1.59 | 128.5 | 1577.4 | 24.9 |
| 2Y | 2.89 | 70 | 1.35 | 129.3 | 1625.4 | 21.1 |
| 2Z | 2.78 | 70 | 14.28 | 118.8 | 1351.0 | 71.3 |
| 2AA | 2.78 | 70 | 6.23 | 123.7 | 1484.1 | 42.4 |
| 2BB | 2.78 | 70 | 4.32 | 125.0 | 1523.9 | 38.4 |
| 2CC | 2.78 | 70 | 2.25 | 126.7 | 1559.3 | 27.0 |
| 2DD | 2.78 | 70 | 1.96 | 127.0 | 1582.7 | 24.5 |
| 2EE | 2.46 | 80 | 11.36 | 123.2 | 1362.5 | 58.8 |
| 2FF | 2.46 | 80 | 2.58 | 125.2 | 1581.6 | 40.9 |
| 2GG | 2.46 | 80 | 2.00 | 127.2 | 1547.3 | 36.3 |
| 2HH | 2.46 | 80 | 1.80 | 127.5 | 1549.5 | 28.2 |
| 2II | 2.46 | 80 | 1.56 | 128.2 | 1597.7 | 19.1 |

As can be seen from the data in Table 4, the polymer compositions containing a calcium salt of rel-(1R,2S)-cyclohexane-1,2-dicarboxylic acid, a zinc salt of a saturated C₁₄-C₂₀ alkyl carboxylic acid (e.g., zinc octadecanoate), and a layered double hydroxide mineral all exhibited improved crystallization half-time, peak polymer recrystallization temperature, top load, and haze relative to the comparable unnucleated resin (having the same melt flow rate) as well as the comparable polymer compositions containing a calcium salt of rel-(1R,2S)-cyclohexane-1,2-dicarboxylic acid, zinc octadecanoate, and calcium octadecanoate. Further, the relative improvements observed for such polymer compositions were greater when the polypropylene homopolymer had a soluble fraction of less 4 wt. %.

### Example 3

This example demonstrates the production of polymer compositions according to the invention and certain physical properties of thin-wall injection molded parts made with such polymer compositions.

Polymer compositions were prepared by weighing the noted amounts of additives into 3 kg batches of polypropylene homopolymer powder, high intensity mixing the combined ingredients, and extruding the resulting mixture into pellets on a single screw extruder. Table 5 sets forth the amount of each additive contained in each polymer composition. All samples were made with a second reactor grade polypropylene homopolymer having a melt flow rate of 70 g/10 min. In Table 5, “N.A. 1” is anhydrous calcium rel-(1R,2S)-cyclohexane-1,2-dicarboxylate, “N.A. 2” is calcium rel-(1R,2S)-cyclohexane-1,2-dicarboxylate monohydrate, and “N.A. 3” is disodium bicyclo[2.2.1]heptane-2,3-dicarboxylate. “N.A. 4” is a hydrotalcite modified with cis-cyclohexane-1,2-dicarboxylic acid as described in International Patent Application Publication No. WO 2024/085755 A1. “ZnOcta” is zinc octadecanoate, and “CaOcta” is calcium octadecanoate. “LDHM 1” is a commercially available aluminum magnesium hydroxide carbonate (DHT-4V™ from Kisuma Chemicals). “Add. 1” is a hydrophobically modified silica (Sylobloc M250 from W.R. Grace Company). Each polymer composition also contained 500 ppm of Irganox® 1010 (BASF) and 1,000 ppm of Irgafos® 168 secondary antioxidant (BASF).

TABLE 5

| | N.A. 1 | N.A. 2 | N.A. 3 | N.A. 4 | ZnOcta | CaOcta | LDHM 1 | Add. 1 |
|---|---|---|---|---|---|---|---|---|
| Sample | (ppm) | (ppm) | (ppm) | (ppm) | (ppm) | (ppm) | (ppm) | (ppm) |
| 3A | | | | | | 500 | | |
| 3B | 350 | | | | | 500 | | |
| 3C | 333 | | | | 167 | 500 | | |
| 3D | 667 | | | | 333 | 500 | | |
| 3E | 333 | | | | 167 | | 300 | |
| 3F | 667 | | | | 333 | | 300 | |
| 3G | | 333 | | | 167 | 500 | | |
| 3H | | 667 | | | 333 | 500 | | |
| 3I | | 333 | | | 167 | | 300 | |
| 3J | | 667 | | | 333 | | 300 | |
| 3K | 192 | | 171 | | 94 | 500 | | 43 |
| 3L | 302 | | 40 | | 148 | 500 | | 10 |
| 3M | 192 | | 171 | | 94 | | 300 | 43 |
| 3N | 302 | | 40 | | 148 | | 300 | 10 |
| 3O | | | | 500 | | | | |
| 3P | | | | 800 | | | | |

The polymer compositions were compounded on a DeltaPlast single screw extruder and injection molded into deli cups as described in Example 2 above. The deli cups were then tested crystallization half-time, peak polymer recrystallization temperature, top load, and haze as described in Example 2 above, and the results are reported in Table 6 below.

TABLE 6

| Sample | t-½ (mins) | T_{c} (° C.) | Top Load (N) | Haze (%) |
|---|---|---|---|---|
| 3A | 14.28 | 118.8 | 1351.0 | 71.3 |
| 3B | 3.92 | 124.8 | 1479.7 | 38.3 |
| 3C | 6.23 | 123.7 | 1484.1 | 42.4 |
| 3D | 4.32 | 125.0 | 1523.9 | 38.4 |
| 3E | 2.25 | 126.7 | 1559.3 | 27.0 |
| 3F | 1.96 | 127.0 | 1582.7 | 24.5 |
| 3G | 5.78 | 122.5 | 1567.3 | 39.9 |
| 3H | 4.16 | 124.0 | 1598.6 | 32.9 |
| 3I | 2.96 | 125.2 | 1682.5 | 27.1 |
| 3J | 3.09 | 125.8 | 1670.6 | 23.7 |
| 3K | 2.25 | 126.8 | 1477.3 | 40.3 |
| 3L | 3.28 | 125.3 | 1534.3 | 35.4 |
| 3M | 1.21 | 129.5 | 1461.4 | 35.1 |
| 3N | 1.74 | 128.2 | 1517.0 | 29.2 |
| 3O | 5.41 | 123.2 | 1390.4 | 50.1 |
| 3P | 12.47 | 122.2 | 1325.0 | 71.4 |

As can be seen from the data in Table 6, the polymer compositions containing a calcium salt of rel-(1R,2S)-cyclohexane-1,2-dicarboxylic acid, a zinc salt of a saturated C₁₄-C₂₀ alkyl carboxylic acid (e.g., zinc octadecanoate), and a layered double hydroxide mineral all exhibited improved crystallization half-time, peak polymer recrystallization temperature, top load, and haze relative to the unnucleated resin as well as the comparable polymer compositions containing a calcium salt of rel-(1R,2S)-cyclohexane-1,2-dicarboxylic acid, zinc octadecanoate, and calcium octadecanoate. Further, the polymer compositions containing a calcium salt of rel-(1R,2S)-cyclohexane-1,2-dicarboxylic acid, zinc octadecanoate, and a layered double hydroxide mineral exhibited markedly better properties than the polymer composition containing a hydrotalcite that had been modified with cis-cyclohexane-1,2-dicarboxylic acid (Samples 30 and 3P).

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the subject matter of this application (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the subject matter of the application and does not pose a limitation on the scope of the subject matter unless otherwise claimed. No language in the specification should be construed as indicating any non-claimed element as essential to the practice of the subject matter described herein.

Preferred embodiments of the subject matter of this application are described herein, including the best mode known to the inventors for carrying out the claimed subject matter. Variations of those preferred embodiments may become apparent to those of ordinary skill in the art upon reading the foregoing description. The inventors expect skilled artisans to employ such variations as appropriate, and the inventors intend for the subject matter described herein to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the present disclosure unless otherwise indicated herein or otherwise clearly contradicted by context.

1. An additive composition comprising:
(a) a calcium salt of rel-(1R,2S)-cyclohexane-1,2-dicarboxylic acid;
(b) a zinc salt of a saturated C₁₄-C₂₀ alkyl carboxylic acid; and
(c) a layered double hydroxide mineral selected from the group consisting of aluminum magnesium hydroxide carbonate, aluminum magnesium zinc hydroxide carbonate, and mixtures thereof.

2. The additive composition of claim 1, wherein the calcium salt of rel-(1R,2S)-cyclohexane-1,2-dicarboxylic acid is anhydrous calcium rel-(1R,2S)-cyclohexane-1,2-dicarboxylate.

3. The additive composition of claim 1, wherein the calcium salt of rel-(1R,2S)-cyclohexane-1,2-dicarboxylic acid is calcium rel-(1R,2S)-cyclohexane-1,2-dicarboxylate monohydrate.

4. The additive composition of claim 1, wherein the calcium salt of rel-(1R,2S)-cyclohexane-1,2-dicarboxylic acid is a mixture of anhydrous calcium rel-(1R,2S)-cyclohexane-1,2-dicarboxylate and calcium rel-(1R,2S)-cyclohexane-1,2-dicarboxylate monohydrate.

5. The additive composition of claim 1, wherein the zinc salt of a saturated C₁₄-C₂₀alkyl carboxylic acid comprises zinc octadecanoate.

6. The additive composition of claim 1, wherein the layered double hydroxide has the formula [[(Mg²⁺)ₐ (Zn²⁺)_{b}]_{1-c} (Al³⁺)_{c} (OH)₂](CO₃²⁻)_{c/2}·nH₂O, where the value of a is from 0 to 1, the value of b is from 0 to 1, the sum of a and b is from 0.5 to 1, the value of c is greater than 0 but no greater than 0.5, and the value of n is from 0 to less than 2.

7. The additive composition of claim 6, wherein the layered double hydroxide mineral is an aluminum magnesium hydroxide carbonate having the formula
[(Mg²⁺)_{1-c} (Al³⁺)_{c} (OH)₂](CO₃²⁻)_{c/2}·nH₂O, where the value of c is greater than 0 but no greater than 0.5, and the value of n is from 0 to less than 2.

8. The additive composition of claim 1, wherein the ratio of the mass of the zinc salt of a saturated C₁₄-C₂₀ alkyl carboxylic acid present in the additive composition to the mass of the calcium salt of rel-(1R,2S)-cyclohexane-1,2-dicarboxylic acid present in the additive composition is about 1:3 to about 1:1.

9. The additive composition of claim 1, wherein the ratio of the mass of the zinc salt of a saturated C₁₄-C₂₀ alkyl carboxylic acid present in the additive composition to the mass of the layered double hydroxide mineral present in the additive composition is about 1:10 to about 2:1.

10. The additive composition of claim 9, wherein the ratio of the mass of the zinc salt of a saturated C₁₄-C₂₀ alkyl carboxylic acid present in the additive composition to the mass of the layered double hydroxide mineral present in the additive composition is about 1:10 to about 1:1.

11. The additive composition of claim 1, wherein the ratio of the combined total mass of the zinc salt of a saturated C₁₄-C₂₀ alkyl carboxylic acid and the layered double hydroxide mineral present in the additive composition to the mass of the calcium salt of rel-(1R,2S)-cyclohexane-1,2-dicarboxylic acid present in the additive composition is about 3:4 to about 15:1.

12. The additive composition of claim 11, wherein the ratio of the combined total mass of the zinc salt of a saturated C₁₄-C₂₀ alkyl carboxylic acid and the layered double hydroxide mineral present in the additive composition to the mass of the calcium salt of rel-(1R,2S)-cyclohexane-1,2-dicarboxylic acid present in the additive composition is about 3:4 to about 2:1.

13. The additive composition of claim 1, wherein the additive composition comprises a pigment selected from the group consisting of blue pigments, violet pigments, black pigments, and mixtures of two or more of the foregoing.

14. The additive composition of claim 13, wherein the additive composition comprises a blue pigment or a violet pigment, and the blue pigment or violet pigment is a sulfur-containing aluminosilicate.

15. The additive composition of claim 1, wherein the additive composition comprises carbon black.

16. The additive composition of claim 1, wherein the additive composition comprises a bicyclo[2.2.1]heptane-2,3-dicarboxylate salt.

17. A polymer composition comprising a polypropylene polymer and the additive composition of claim 1.

18. The polymer composition of claim 17, wherein the polypropylene polymer is a polypropylene homopolymer.

19. The polymer composition of claim 17, wherein the polypropylene polymer has a melt flow rate of 10 g/10 min or more.

20. The polymer composition of claim 17, wherein the polypropylene polymer has a melt flow rate of about 50 g/10 min or more.

21. The polymer composition of claim 17, wherein the calcium salt of rel-(1R,2S)-cyclohexane-1,2-dicarboxylic acid is present in the polymer composition in an amount of about 100 ppm to about 1,000 ppm, based on the total weight of the polymer composition.

22. The polymer composition of claim 17, wherein the layered double hydroxide mineral is present in the polymer composition in an amount of about 100 ppm to about 1,000 ppm, based on the total weight of the polymer composition.
